(19) United States
(12) Patent Application Publication
(10) Pub. No.: US 2025/0205859 A1
(43) Pub. Date: Jun. 26, 2025

(54) Adjustable Wrench

(71) Applicant: Questar Gas Company, Salt Lake City, UT (US)

(72) Inventor: Carter Worthen, Santaquin, UT (US)

(73) Assignee: Questar Gas Company, Salt Lake City, UT (US)

(21) Appl. No.: 19/000,006

(22) Filed: Dec. 23, 2024

Related U.S. Application Data
(60) Provisional application No. 63/614,005, filed on Dec. 22, 2023.

(51) Int. Cl. B25B 23/00; B25B 13/48; B25B 13/50

(52) U.S. Cl. CPC B25B 23/0028; B25B 13/481; B25B 13/50

(57) ABSTRACT

A versatile gas meter wrench has two pivotal connections. The gas meter wrench has a wrench body. The wrench head defining a barrel nut receiving portion is pivotally connected to the wrench body and a wrench shaft for manipulating the wrench head is pivotally attached to the wrench body. The versatile gas meter wrench allows a user to more completely adjust the angle between the wrench head and the wrench shaft to provide a more comfortable angle to manipulate the wrench for tightening or loosening the barrel nut.

### FIELD OF THE INVENTION

Gas meters measure the natural gas flow from a common supply piping system to the consumer piping system so that the gas supply company can properly monitor the usage of each customer. Conventionally, the gas meters are connected to the supply piping and the consumer piping by barrel nuts threaded on the inlet connector and outlet connector on a top portion of the meter. A wrench is needed to tighten and loosen these barrel nuts.

### BACKGROUND

Gas meters are connected between the common supply piping system and the residential or commercial consumers piping system. The residential or commercial consumers may have multiple appliances that consume natural gas such as, but not limited to, hot water heaters, furnaces, boilers, stoves, grills, and ovens, for example, that are connected to the consumer piping system. The gas meters are specifically designed to measure the flow of natural gas through the meter and into the consumer piping system for use, typically combustion.

A typical gas meter installation is shown in FIG. 1. The are many regulations controlling the installation of these gas meters. The common supply piping and the consumer piping systems are connected to male fittings on top of the gas meter by barrel nuts. The barrel nuts need to be tightened during installation and loosened during removal. The meters must be removed to change or upgrade the meter or to perform repairs on the meter.

There are several reasons that barrel nuts are difficult to remove or properly tighten. As shown in FIG. 1, a gas meter is typically installed close to the exterior wall of the consumer's building or home. Also, the inlet pipe and the outlet pipe are parallel to each other and interfere with use of a wrench to manipulate the barrel nuts. Further, gas meters are installed outside, and the nuts corrode and may seize to the male fitting.

The combination of difficulty in manipulating the wrench due to obstructions and the difficulty in removing corroded nuts results in more time than necessary to complete the job and a higher risk of injury due to the awkward positioning of the wrench and the effort required to loosen the barrel nut.

There is a need for a gas meter wrench that overcomes these difficulties.

### BRIEF DESCRIPTION OF THE DRAWINGS

FIG. 1 depicts a typical gas meter installation with barrel nuts with the gas meter installed adjacent to a residence;

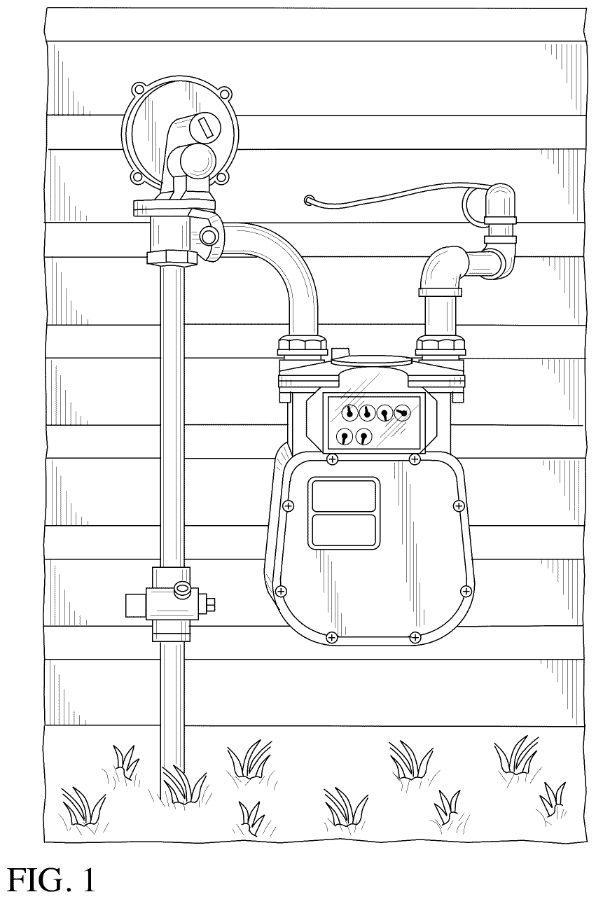

FIG. 2. depicts an embodiment of the gas meter wrench with the wrench head and adjustment pin disconnected;

FIG. 3 depicts an embodiment of the gas meter wrench with the gas meter shaft installed in line with the gas meter body and the gas meter wrench head adjusted at an angle of less than ninety degrees to the wrench body and the wrench shaft;

FIG. 4 depicts an embodiment of the gas meter wrench with the gas meter shaft installed at approximately a 45 degree angle from shaft body and the shaft head adjustment pin extracted sufficiently that the wrench head is perpendicular to the wrench body;

FIG. 5 depicts an embodiment of the gas meter wrench with the gas meter shaft installed with an angle between zero degrees and 45 degrees with the gas meter body;

FIG. 6 depicts an embodiment of the gas meter wrench with the gas meter shaft installed in line with the gas meter body;

FIG. 7A and 7B depicts how the angle of the wrench head versus the wrench body can be adjusted using the adjustment pin.

### DESCRIPTION OF THE INVENTION

A unique wrench has been developed to improve manipulating the wrench onto the nut and improved positioning of the shaft of the wrench to provide sufficient leverage and ergonomic positioning relative to the user.

An embodiment of the wrench comprises a wrench body pivotally connected to a wrench head for encompassing a bolt head or nut to be rotated. The embodiment of the wrench may further comprise a wrench shaft, wherein the wrench shaft is pivotally attached to the wrench body. The angle between the wrench shaft and the wrench body may be changed to move the wrench shaft away from any obstructions that may interfere with rotation of the wrench shaft during use. The wrench head may also be rotated to allow the wrench head to be more easily manipulated over the bolt head and nut. In some embodiments, the wrench head is profiled to be used on a gas meter barrel nut.

Any means for adjusting the angle between the wrench body and the wrench head may be used or adjusting the angle between the wrench body and the wrench shaft. In the embodiment shown in the figures, the wrench body defines a plurality of head apertures, and the wrench head defines a first body aperture. A head pivoting pin may be reversibly inserted through one of the plurality of head apertures and the first body aperture to create a pivoting connection between the wrench head and the wrench body. The head pivoting pin defines the pivoting point between the wrench head and the wrench body.

In the shown embodiment, the wrench shaft may also be pivoted relative to the wrench body. In such an embodiment, the wrench body defines a plurality of shaft locking apertures and the wrench shaft defines a third body aperture. A shaft locking pin may be reversibly inserted through the shaft locking aperture and the third body aperture to lock the relative angle between the wrench shaft and the wrench body. The wrench body may comprise a plurality of shaft locking apertures so the wrench shaft angle with the wrench body may be adjusted to the desired position.

Other configurations are possible. For example, the wrench shaft may comprise a plurality of third body aperture. This plurality of third locking holes may replace the plurality of shaft locking holes or be in addition to the shaft locking holes.

The shaft head may comprise a similar adjustment assembly. However, the embodiment of the wrench shown in the figures comprises a wrench body comprising a head angle adjustment pin within an adjustment aperture in the wrench body and the wrench head comprises a head angle adjustment pin contact portion. The head angle adjustment pin may be moved toward or away from the head contact portion to adjust the angle of the wrench head relative to the wrench body.

In one embodiment, for example, the head angle adjustment pin is a threaded rod or bolt, and the adjustment aperture is internally threaded. In such an embodiment, rotating the head angle adjustment pin cause longitudinal movement of the pin relative to the wrench body and, therefore, adjustment of the angle between the wrench head and the wrench body. In the embodiment shown in the figures the wrench head comprises a finger extending from the wrench head, wherein the finger comprises the head angle adjustment pin contact portion. The finger allows more leverage and finer adjustment of the wrench head angle with the wrench body.

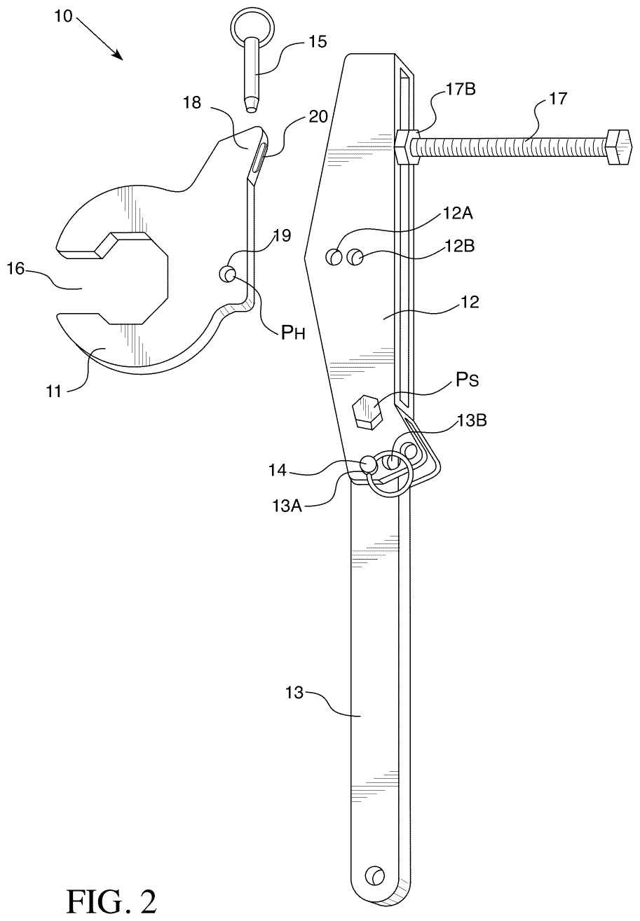

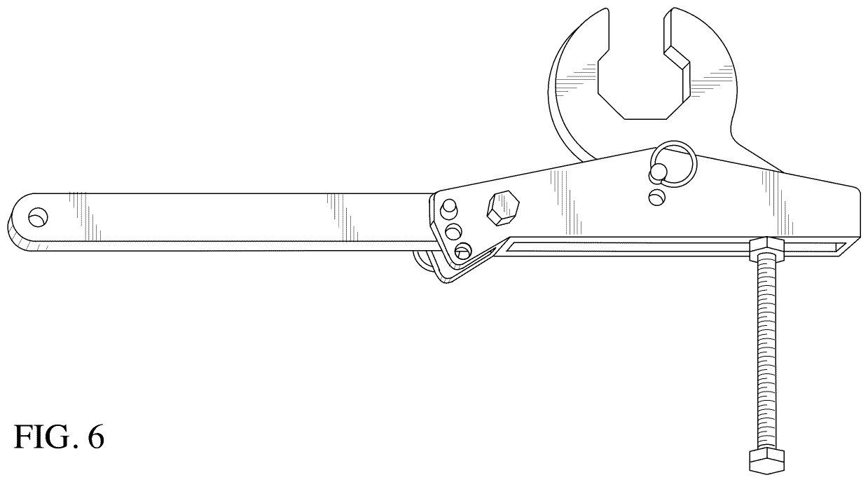

An embodiment of a gas meter wrench of the invention is shown in FIGS. 2 to 7. FIG. 2 shows the gas meter wrench 10 in a partially disassembled configuration. This embodiment of the gas meter wrench comprises a wrench body 12 pivotally connected to a wrench head 11. The wrench head 11 is profiled for encompassing a barrel nut 16 on a gas meter. Other configurations of the wrench head may be incorporated.

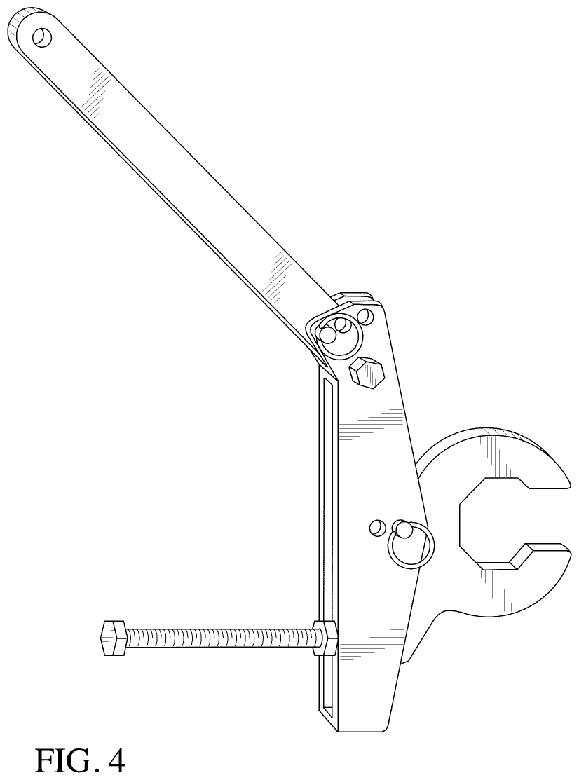

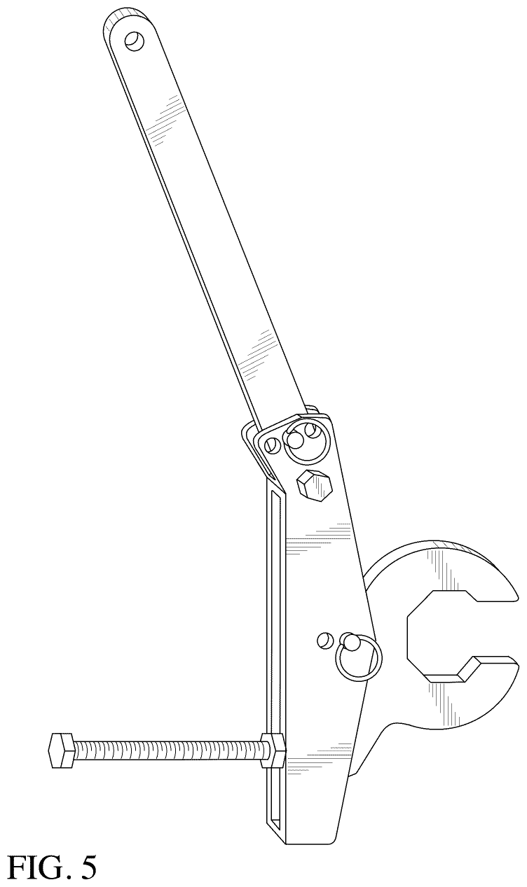

The gas meter wrench 10 (and other embodiments of the wrench) comprise various pivoting connections to allow configuration of the various angles between the wrench head 11 and the wrench body 12 and the wrench shaft 13 and the wrench body 12 in order to allow use of the wrench in confined spaces and move the wrench shaft to a position that may be more easily manipulated to the operator, improve leverage, and reduce injuries. The wrench shaft 13 is pivotally attached to the wrench body 12 with a bolt at pivot point Ps. The angle between the wrench shaft 13 and the wrench body 12 may be changed to move the wrench shaft away from any obstructions that may interfere with rotation of the wrench shaft 13 during use. In FIGS. 2, 3, and 6, the wrench shaft 13 is shown in a substantially linear alignment) (180°) relationship with the wrench body 12. The wrench shaft 13 may be unlocked and pivoted around pivot point 14 and then locked at a new angle as shown in FIGS. 4 and 5.

The wrench shaft 12 may be pivoted and locked in various angular positions relative to the wrench body 12 by removing and reinserting the shaft locking pin 14 into one of the plurality of shaft locking apertures 13A 13B etc. and the third body aperture on the wrench shaft (not shown). If manipulating the wrench shaft 13 is obstructed or in an awkward position when mounted on the gas meter barrel nut, the shaft locking pin may be removed from its current location and reversibly inserted through the shaft locking aperture and the third body aperture to lock the wrench shaft at a new relative angle between the wrench body. The wrench body 12 comprises a plurality of shaft locking apertures 13A 13B . . . so the wrench shaft angle with the wrench body may be adjusted to the desired position.

The wrench head 11 may also be rotated to allow the wrench head 11 to be more easily manipulated over the gas meter barrel nut or to also adjust the position of the wrench shaft 13 relative to the gas meter barrel nut position.

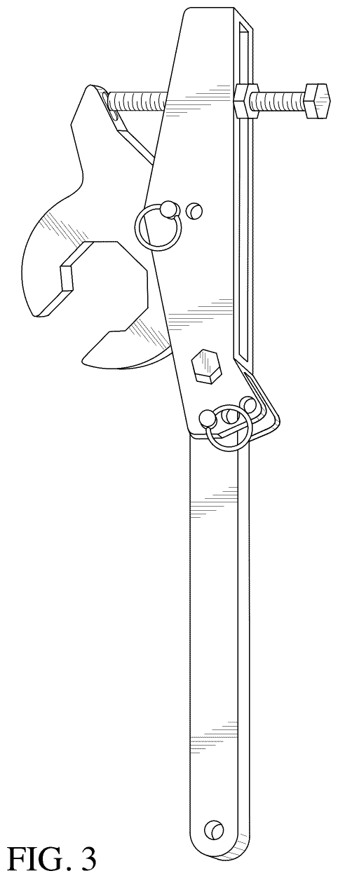

The wrench body 12 defines a plurality of head apertures 12A 12B etc. and the wrench head 11 defines a first body aperture at pivot point PH. A head pivoting pin 15 may be reversibly inserted through one of the plurality of head apertures 12A 12B etc. (as shown in FIGS. 3 and 4, for example) and the first body aperture 19 to create a pivoting connection between the wrench head 11 and the wrench body 12. The head pivoting pin 15 defines the pivoting point PH between the wrench head 11 and the wrench body 12.

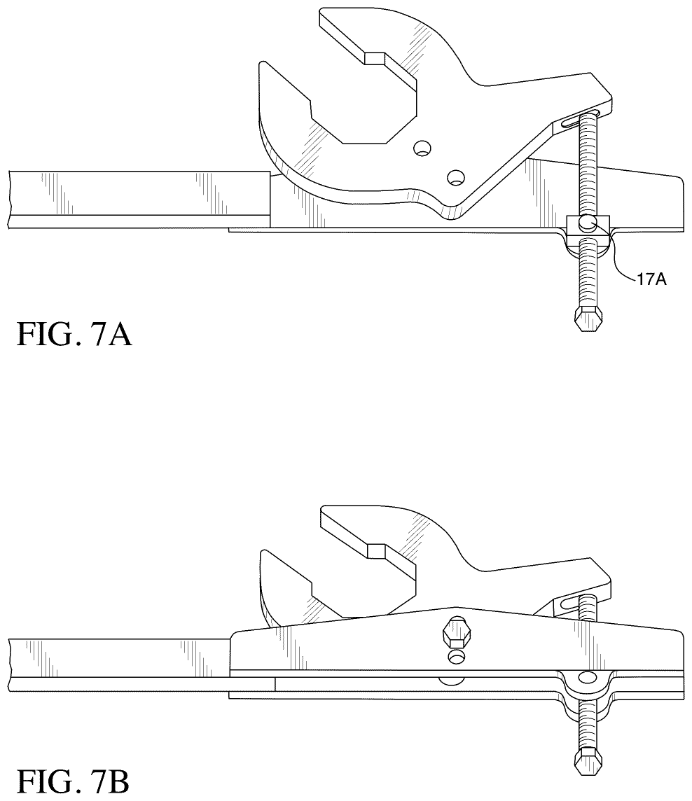

In the gas meter wrench shown in the figures, the wrench body 12 is rotatably connected to a head angle adjustment pin 17 within a rigid adjustment aperture 17B in FIG. 2 or a swiveling adjustment aperture 17A in FIG. 7. The wrench head 11 has a head angle adjustment pin contact portion 18. The head angle adjustment pin 17 may be moved toward or away from the head contact portion 18 to adjust the angle of the wrench head 11 relative to the wrench body 12.

As shown in FIG. 2, the wrench head 11 may comprise a finger 18. The finger may comprise the head angle adjustment pin contact portion 20. In the embodiment of FIG. 2, the head angle adjustment is not connected to the angle adjustment pin contact portion 20. However, in the embodiment shown in FIG. 7, the head angle adjustment is connected to the angle adjustment pin contact portion 20.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described to best explain the principles of the invention and the practical application, and to enable others of ordinary skill in the art to understand the invention for various embodiments with various modifications as are suited to the particular use contemplated.

1. A wrench, comprising:
a wrench body;
a wrench head, wherein the wrench head is pivotally attached to the wrench body; and
a wrench shaft, wherein the wrench shaft is pivotally attached to the wrench body.

2. The wrench of claim 1, wherein the wrench head is profiled for a gas meter barrel nut.

3. The wrench of claim 1, wherein the wrench body defines a plurality of head apertures and the wrench head defines a first body aperture.

4. The wrench of claim 3, wherein a head pivoting pin is reversibly inserted through one of the plurality of head apertures and the first body aperture to create a pivoting connection between the wrench head and the wrench body.

5. The wrench of claim 1, wherein the wrench body defines at least one shaft pivot aperture and the wrench shaft defines a second body aperture.

6. The wrench of claim 5, wherein a shaft pivoting pin is inserted through the shaft pivot aperture and the second body aperture to create a pivoting connection between the wrench shaft and the wrench body.

7. The wrench of claim 6, wherein the wrench body defines a plurality of shaft locking apertures and the wrench shaft defines a third body aperture, wherein a shaft locking pin is reversibly inserted through the shaft locking aperture and the third body aperture to lock the relative angle between the wrench shaft and the wrench body.

8. The wrench of claim 1, wherein the wrench body comprises a head angle adjustment pin within an adjustment aperture in the wrench body and the wrench head comprises a head angle adjustment pin contact portion.

9. The wrench of claim 8, wherein the head angle adjustment pin is a threaded rod and the adjustment aperture is internally threaded.

10. The wrench of claim 9, wherein rotating the head angle adjustment pin is rotated to adjust the angle between the wrench head and the wrench body.

11. The wrench of claim 10, wherein the wrench head comprise a finger, wherein the finger comprises the head angle adjustment pin contact portion.

12. The wrench of claim 11, wherein the head angle adjustment pin is rotatably connected to the wrench body.

13. The wrench of claim 12, wherein the head angle adjustment pin is connected to the wrench body.
